(19) United States
(12) Patent Application Publication
(10) Pub. No.: US 2025/0129582 A1
(43) Pub. Date: Apr. 24, 2025

(54) WATER SUPPLY DEVICE AND FAUCET HAVING THE SAME

(71) Applicant: LG ELECTRONICS INC., Seoul (KR)

(72) Inventors: Duchan KI, Seoul (KR); Ok Sun YU, Seoul (KR); Junho LEE, Seoul (KR)

(21) Appl. No.: 18/757,930

(22) Filed: Jun. 28, 2024

(30) Foreign Application Priority Data
Jun. 29, 2023 (KR) 10-2023-0084422
Jun. 28, 2024 (KR) 10-2024-0085727

(51) Int. Cl. E03C 1/04

(52) U.S. Cl. CPC E03C 1/04; E03C 2201/40

(57) ABSTRACT

Disclosed are a water supply device and a faucet including the same. The water supply device includes a casing, and a component storage part formed inside the casing. A flow path guide pack is disposed inside the casing. The flow path guide pack defines a portion of the component storage part. Each of a thermostat, a flow rate controller, a filter, and a water-flow generator is connected to the flow path guide pack. In this case, the thermostat, the flow rate controller, the filter, and the water-flow generator are disposed in the component storage part. The filter and the water-flow generator are disposed between the flow rate controller and the thermostat.

### CROSS-REFERENCE TO RELATED PATENT APPLICATIONS

This application claims priority to Korean Patent Application Nos. 10-2023-0084422, filed Jun. 29, 2023 and 10-2024-0085727, filed Jun. 28, 2024, whose entire disclosures are hereby incorporated by reference.

### Field of the Invention

The present disclosure relates to a water supply device and a faucet.

### Background Art

A water supply device is a device for supplying water to a user. When a user operates the water supply device, water stored in the water supply device or raw water supplied from outside may be supplied to the user through the water supply device. An example of the water supply device is a faucet used in a bathroom or kitchen.

The faucet may supply cold water and hot water from externally supplied raw water to a user. The faucet may provide a user with either cold water or hot water, or a mixture of cold water and hot water. Recently, a device such as a filter or a thermostat has been mounted inside the faucet.

Accordingly, a plurality of flow paths may be provided inside the faucet to mix the raw water or allow the raw water to pass through a device such as the filter or the thermostat. The plurality of flow paths may be implemented as a plurality of hoses. However, the plurality of hoses complicates the structure of the faucet and increases the number of parts, thereby reducing manufacturing convenience. In addition, each of the hoses has a small flow path cross-sectional area compared to an overall volume, which is disadvantageous in securing a large flow rate and causes the problem of the flow path being blocked when the hose is excessively bent.

Meanwhile, recently, technologies to supply power to a display by mounting a water-flow generator inside the faucet have been developed. Specifically, technologies to measure water quality or light an LED by mounting a power generation means (a generator) inside a shower are disclosed. In these prior arts, since the generator is arranged on the showerhead side rather than in a faucet body, a function to utilize generated power is limited, and it is difficult to transmit the generated power to the faucet body. The generator may be installed in the faucet body, but in this case, the flow path structure of the faucet body may be more complicated.

### DETAILED DESCRIPTION OF THE DISCLOSURE

### Technical Problem

The present disclosure has been made to solve the above problems occurring in the related art, and an objective of the present disclosure is to arrange a flow path guide pack inside a water supply device, and to arrange components such as a filter and a water-flow generator in a distributed manner in front of the flow path guide pack.

Another objective of the present disclosure is to mount the filter and the water-flow generator inside the water supply device, and to form all flow paths connecting hot water/cold water/mixed water with the filter and the water-flow generator in one flow path guide pack.

Still another objective of the present disclosure is to add a display so as not to interfere with the filter and the water-flow generator inside the water supply device.

### Technical Solution

In order to achieve the objectives of the present disclosure as described above, according to the characteristics of the present disclosure, a water supply device of the present disclosure may include a casing, and a component storage part formed inside the casing. A flow path guide pack may be disposed inside the casing. The flow path guide pack may define a portion of the component storage part. Each of a thermostat, a flow rate controller, a filter, and a water-flow generator may be connected to the flow path guide pack. In this case, the thermostat, the flow rate controller, the filter, and the water-flow generator may be disposed in the component storage part. The filter and the water-flow generator may be disposed between the flow rate controller and the thermostat.

The water-flow generator and the filter may be disposed on a front of the flow path guide pack.

The water-flow generator and the filter may be disposed to be spaced apart from each other on left and right.

The water-flow generator and the filter may be received in a component storage part in a first direction which is a front-rear direction. The water-flow generator and the filter may be connected to the flow path guide pack in the first direction.

Flow paths formed inside the flow path guide pack may be formed in a second direction orthogonal to the first direction.

A filter part may be stored inside the filter. The filter part may be attached and detached in the second direction.

The filter may be disposed closer to the flow rate controller than to the water-flow generator.

Each of a filter inlet and a filter outlet of the filter connected to the flow path guide pack may be open in the front-rear direction toward the flow path guide pack.

A power generation inlet of the water-flow generator connected to the flow path guide pack may be open in the front-rear direction toward the flow path guide pack.

The filter inlet and the filter outlet may be disposed on a higher or equal position than the power generation inlet.

A water discharge selector that selectively discharges raw water inside the flow path guide pack to the outside may be disposed in the component storage part. The water-flow generator may be disposed on a rear side closer to the flow path guide pack than the water discharge selector.

The water-flow generator may be stacked on an upper portion of the water discharge selector.

The water-flow generator may include the power generation inlet connected to the flow path guide pack, and a power generation outlet connected to the water discharge selector.

A lower end of the water-flow generator may be spaced further apart upward from a bottom surface of the component storage part than a lower end of the filter.

A display which receives power from the water-flow generator may be disposed in the component storage part.

The display may be disposed on an opposite side of the filter, relative to the water-flow generator.

The display may be disposed between the flow rate controller and the thermostat. The display may be disposed closer to the thermostat than the flow rate controller.

The flow path guide pack may be provided with an inlet through which external raw water is introduced. The inlet may be open in the first direction in which the filter and the water-flow generator are connected to the flow path guide pack. The inlet may be provided on an opposite side of the component storage part, relative to the flow path guide pack.

The flow path guide pack may be provided with a pair of inlets through which external raw water is introduced. The pair of inlets may be disposed between the flow rate controller and the thermostat.

The flow path guide pack may be provided with an outlet configured to supply the raw water to the outside. The outlet may be open in the second direction orthogonal to the first direction.

### Advantageous Effects

As described above, the water supply device according to the present disclosure and the faucet including the same may have the following effects.

According to the present disclosure, the flow path guide pack that guides the flow of water may be arranged inside the water supply device. The flow path guide pack may be provided with flow paths that are independent of the intimal space of the water supply device, allowing water introduced from the outside to be branched and discharged. Since water flows through the flow path of the guide pack, complex flow paths may be implemented without a plurality of hoses. Accordingly, the internal structure of the water supply device may be simplified, and a decrease in a flow rate due to hoses being folded may be prevented.

In addition, the flow path guide pack may be disposed at a rear side inside the water supply device. At the same time, components such as the filter and the water-flow generator, etc. may be disposed on the front of the flow path guide pack inside the water supply device. Distributed arrangement of these components may increase the installation stability of the water supply device.

Particularly, according to the present disclosure, inside the water supply device, the filter and the water-flow generator may be disposed between the flow rate controller and the thermostat which are relatively heavy. In this case, the weight of the water supply device may be distributed throughout, and flow paths formed inside the flow path guide pack may be formed with a simple structure. Therefore, the effect of facilitating the manufacture of the water supply device may be obtained.

Additionally, according to the present disclosure, the flow path guide pack may be responsible for the inflow/branch/discharge of water, and thus the internal structure of the water supply device may be simplified even if components such as a filter, a water-flow generator, and a thermostat are mounted in the water supply device.

In addition, according to the present disclosure, the filter and the water-flow generator may be assembled in the first direction (front-rear direction) toward the flow path guide pack. In this case, each of connectors of the filter, the water-flow generator, and the flow path guide pack is formed in the first direction, and thus in the process of assembling the filter and the water-flow generator with the flow path guide pack, flow paths thereof may be naturally connected to each other, and assembling efficiency thereof may be improved.

In addition, each of the flow paths inside the flow path guide pack may be formed in the second direction orthogonal to the first direction. In this case, it is possible to prevent the thickness of the water supply device from increasing in the front-rear direction, and as a result, it is possible to realize miniaturization of the water supply device.

Furthermore, according to the present disclosure, the flow path guide pack may be detachably arranged inside the water supply device, so when the flow paths are blocked or damaged, only the flow path guide pack may be removed and replaced. That is, the maintainability of the water supply device may be high since only the flow path guide pack is replaced without the need to replace the entirety of water supply device.

In addition, according to the present disclosure, the filter may be placed inside the water supply device to discharge incoming water after purifying the incoming water. Since the filter is arranged inside the body of the water supply device rather than a final discharge device such as a shower head, there is no need to install a filter on each of a plurality of discharge devices. Therefore, the number of parts (filters) for purification may be reduced, and replacement of the filter may become easier.

Particularly, according to the present disclosure, the filter part mounted inside the filter may be mounted in a second direction which is a vertical direction of the water supply device. Accordingly, the replacement of the filter may be facilitated, and since the entrance of the filter is usually covered, aesthetics may be improved.

Furthermore, since the flow path guide pack takes charge of the flow paths, the wide internal space of the water supply device may be secured, so the capacity of the filter may be increased. Accordingly, the replacement cycle of the filter may be increased, and usability of the water supply device may be improved.

Additionally, according to the present disclosure, the water-flow generator may be installed in the water supply device. The water-flow generator may use water pressure to generate electrical energy and may supply the electrical energy to the display. According to the present disclosure, since the water-flow generator is arranged inside the main body of the water supply device rather than the final discharge device such as the shower head, the water-flow generator may provide various information to a user through the display of the body or utilize communication means or lighting devices.

In addition, according to the present disclosure, in the water flow paths, the water-flow generator may be arranged behind the filter, so that the generator may be operated by purified water. In this case, water from which impurities have been removed may be supplied to the water-flow generator, so the durability of the water-flow generator may be improved.

Additionally, according to the present disclosure, the water discharge selector may be arranged between the flow path guide pack and the outlet, so the discharge direction of water may be selected. In this case, the water discharge selector and the water-flow generator may be stacked to be located at different heights, so it is possible to prevent the volume of the water supply device from becoming excessively large due to the water discharge selector and the water-flow generator.

Furthermore, according to the present disclosure, when the water-flow generator and the water discharge selector inside the water supply device are arranged to have a stacked structure at different heights, water that has passed through the water-flow generator may be directly supplied to the water discharge selector, so a flow path connecting the water-flow generator and the water discharge selector to each other may be implemented to have a minimum length, and the internal space of the water supply device may also be utilized effectively.

In addition, according to the present disclosure, the water supply device may be provided with a thermostat that controls the temperature of water and a flow rate controller that controls a flow rate. In this case, the thermostat and the flow rate controller may be arranged symmetrically on opposite ends of the body of the water supply device, and through this, the water supply device may provide a unified aesthetics.

Additionally, the filter, the water-flow generator, and the water discharge selector may be arranged in an empty space between the thermostat and the flow rate controller. Through this arrangement, the internal space of the water supply device may be utilized efficiently.

### BRIEF DESCRIPTION OF THE DRAWINGS

FIG. 1 is an example view illustrating the structure of a faucet to which a water supply device according to a first embodiment of the present disclosure is applied.

FIG. 2 is a side view illustrating a state in which the water supply device according to the first embodiment of the present disclosure is installed on a wall surface.

FIG. 3 is a bottom view illustrating the structure of the water supply device according to the first embodiment of the present disclosure.

FIG. 4 is a rear view illustrating the structure of the water supply device according to the first embodiment of the present disclosure.

FIG. 5 is an exploded perspective view of components constituting the water supply device according to the first embodiment of the present disclosure.

FIG. 6 is an exploded perspective view of remaining components after removing a casing constituting the water supply device according to the first embodiment of the present disclosure.

FIG. 7 is an exploded perspective view of the remaining components when viewed at an angle different from FIG. 6 after removing the casing constituting the water supply device according to the first embodiment of the present disclosure;

FIG. 8 is a cross-sectional view taken along line VIII-VIII′ of FIG. 5.

FIG. 9 is a front view illustrating the remaining components after removing the casing constituting the water supply device according to the first embodiment of the present disclosure.

FIG. 10 is a rear view illustrating the remaining components after removing the casing constituting the water supply device according to the first embodiment of the present disclosure.

FIG. 11 is a plan view illustrating the remaining components after removing the casing constituting the water supply device according to the first embodiment of the present disclosure.

FIG. 12 is a bottom view illustrating the remaining components after removing the casing constituting the water supply device according to the first embodiment of the present disclosure.

FIG. 13 is an exploded perspective view of the structure of a flow path guide pack and a reinforcing plate constituting the water supply device of the present disclosure according to the first embodiment.

FIG. 14 is an exploded perspective view of the structure of the flow path guide pack and the reinforcing plate constituting the water supply device of the present disclosure according to the first embodiment viewed at an angle different from FIG. 13.

FIG. 15 is a cross-sectional view taken along line XV-XV of FIG. 5.

FIG. 16 is a perspective view illustrating the water supply device according to the second embodiment of the present disclosure.

FIG. 17 is a perspective view illustrating a third embodiment of the water supply device according to the present disclosure.

### BEST MODE FOR INVENTION

Below, some embodiments of the present disclosure are described in detail through illustrative drawings. When adding reference numerals to components in each drawing, it should be noted that identical components are given the same reference numerals as much as possible even if they are shown in different drawings. Additionally, when explaining an example of the present disclosure, if a detailed description of the related known structure or function is determined to impede understanding of the embodiments of the present disclosure, the detailed description thereof is omitted.

The present disclosure relates to a water supply device 10. The water supply device 10 of the present disclosure may provide raw water supplied from an external water source by treating the raw water in various ways. The water supply device 10 may be applied to a faucet or other water supply devices. Here, the faucet may include a faucet used in a bathroom, such as a faucet for a shower, and a faucet used in a kitchen, such as a faucet for a sink. Additionally, the faucet may be used as an outdoor faucet in addition to as an indoor faucet. The water supply device 10 may also be applied to a home appliance that supplies water, such as a water purifier.

Here, raw water, which is water supplied from the outside, may be tap water. More specifically, the raw water may include cold water and hot water. For reference, hereinafter, raw water refers to water introduced from the outside, mixed water refers to the mixed water of the cold water and the hot water, controlled water refers to water whose flow rate is controlled by a flow rate controller 150, and purified water refers to water from which impurities have been filtered out by a filter 160.

The water supply device 10 of the present disclosure may provide functions such as mixing of cold water and hot water, purification of water, power supply through a generator 170, information transmission through a display 70, data reception/sending through a communication means, automatic control through a control device, or water discharge through a plurality of water outlets. Hereinafter, a structure in which the weight of the water supply device 10 including a flow path guide pack 100 for distributing water is distributed and components such as the flow path guide pack 100, the filter 160, and the generator 170 are effectively arranged will be mainly described.

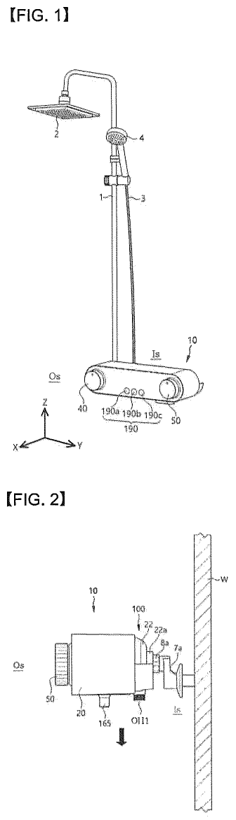

For reference, below, the front-rear direction of the water supply device 10 indicates the X-axis direction of FIG. 1. The left-right direction of the water supply device 10 indicates the Y-axis direction of FIG. 1. The upper side and lower side direction of the water supply device 10 indicates the Z-axis direction of FIG. 1. In addition, the front side of the water supply device 10 refers to a side in front of the water supply device 10, which is far from an installation surface W, and is marked with Os in FIG. 1. The rear side of the water supply device 10 refers to a side thereof directed to the installation surface W, and is marked with Is in FIG. 1.

Referring to FIG. 1, the water supply device 10 is illustrated to be used as a faucet for shower. A shower may include a first water discharge pipe 1, and a rainfall shower head 2 connected to the first water discharge pipe 1. The shower may include a handheld shower head 4 connected to a second water discharge pipe 3. The second water discharge pipe 3 may be made of a flexible hose material.

The rainfall shower head 2 and the handheld shower head 4 may receive water from the water supply device 10. The water supply device 10 may receive raw water from the outside and transmit the raw water to the rainfall shower head 2 and the handheld shower head 4. Although not shown in FIG. 1, the water supply device 10 may include a lower water outlet 25 (see FIG. 3) for discharging water into a bathtub. Hereinafter, the rainfall shower head 2 will be referred to as a first water discharge part, the handheld shower head 4 will be referred to as a second water discharge part, and the lower water outlet 25 will be referred to as a third water discharge part.

Accordingly, in this embodiment, the water supply device 10 may include a plurality of water discharge parts. Here, the water discharge parts may include the rainfall shower head 2, the handheld shower head 4, and the lower water outlet 25. The water supply device 10 may branch water inside and may transmit the water to any one of the plurality of water discharge parts or to the plurality of water discharge parts.

FIG. 1 illustrates a first knob 40 of a thermostat 140 to control the temperature of water. When the first knob 40 rotates, the thermostat 140 may operate and mixed water including hot and cold water may be discharged, or hot water or cold water may be discharged without mixing with each other. The water supply device 10 may further include a second knob 50 separately from the first knob 40. The second knob 50 is used to operate the flow rate controller 150 for controlling the flow rate of discharged water. When the second knob 50 is rotated, a discharged flow rate may be controlled.

In addition to the first knob 40 and the second knob 50, the water supply device 10 may include selection levers 190. The selection levers 190 may be connected to a water discharge selector 180 to be described below. The water discharge selector 180 allows a user to select which water discharge part among the plurality of water discharge parts to discharge water. In this embodiment, the water discharge selector 180 may include a total of three selection levers 190. The three selection levers 190 may allow water to be discharged to the rainfall shower head 2, the handheld shower head 4, and the lower water outlet 25, respectively.

The selection levers 190 may be placed between the thermostat 140 and the flow rate controller 150. The thermostat 140 and the flow rate controller 150 may be respectively arranged on opposite front ends of the water supply device 10. The selection levers 190 may be arranged between the thermostat 140 and the flow rate controller 150. In this case, the water supply device 10 may provide a user with a unified aesthetics through a symmetrical structure thereof. The thermostat 140, the flow rate controller 150, and the water discharge selector 180 will be described in detail below.

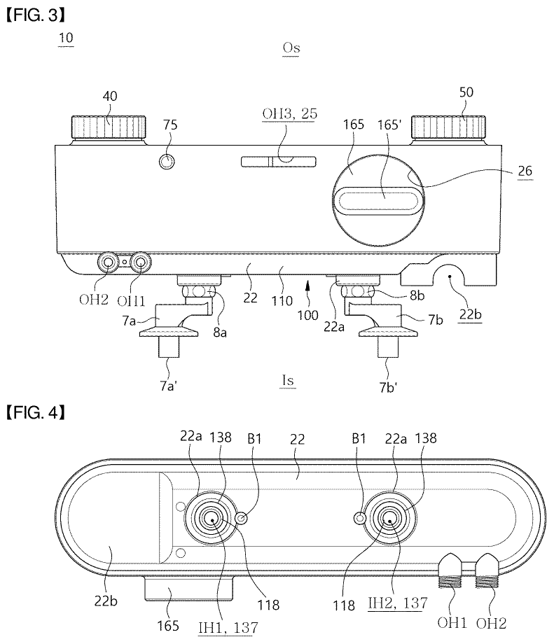

Referring to FIG. 2, the water supply device 10 is shown to be installed on a wall surface, which is the installation surface W. In this way, the rear surface of the water supply device 10 may face the installation surface W, and the water supply device 10 may protrude from the installation surface W. The water supply device 10 may be fixed to the installation surface W through installation adapters 7a and 7b for wall mount. Accordingly, a large load due to the weight of the water supply device 10 may be concentrated on the installation adapters 7a and 7b. In this embodiment, as will be described below, the load applied to the installation adapters 7a and 7b may be reduced through the structure of the flow path guide pack 100, the arrangement of parts thereof, and a reinforcing plate 130 thereof. For another example, the water supply device 10 may be stored in a storage part recessed in a wall surface. For still another example, the lower part of the water supply device 10 may be supported by the installation adapters 7a and 7b connected to the lower part of the water supply device 10.

Each of the installation adapters 7a and 7b may be coupled to a raw water inlet (not shown). More precisely, each of the installation adapters 7a and 7b may be regarded as a type of coupler connecting the raw water inlet and the water supply device 10 to each other. Since raw water supplied from the raw water inlet is delivered to the water supply device 10 through each of the installation adapters 7a and 7b, each of the installation adapters 7a and 7b may also be regarded as a part of the raw water inlet. In this case, the raw water inlet may be mounted inside the installation surface W. The raw water inlet may constitute one end part of a pipe connected to an external water source. The raw water inlet may be coupled to a first end part of each of the installation adapters 7a and 7b, and a second end part of each of the installation adapters 7a and 7b may be coupled to the water supply device 10.

As illustrated in FIGS. 2 and 3, on the lower portion of the water supply device 10, outlets OH1, OH2, and OH3 and a handle 165′ of the filter 160, which will be described later, may be exposed. A user may hold the handle 165′ and separate and replace a filter part 163, which constitutes the filter 160. In this embodiment, the filter part 163 may be mounted/detached in a vertical direction, and this structure will be described again below.

Referring to FIG. 3 showing the lower side of the water supply device 10, the plurality of outlets OH1, OH2, and OH3 may be open on the lower side of the water supply device 10. The plurality of outlets OH1, OH2, and OH3 may include a first outlet OH1, a second outlet OH2, and a third outlet OH3. Separate hoses may be connected to the first outlet OH1 and the second outlet OH2. In this embodiment, the first outlet OH1 and the second outlet OH2 are arranged adjacent to each other, but in another example, the first outlet OH1 and the second outlet OH2 may be spaced apart from each other.

The first outlet OH1 and the second outlet OH2 may be disposed at a position close to the rear of the water supply device 10. On the basis of FIG. 3, the first outlet OH1 and the second outlet OH2 may be disposed on the lower side of the water supply device 10. That is, the first outlet OH1 and the second outlet OH2 may be disposed close to the installation surface W. In this case, when hoses are connected to the first outlet OH1 and the second outlet OH2, a bending moment applied to a connection portion of the installation adapters 7a and 7b and the flow path guide pack 100 or the reinforcing plate 130, which will be described, due to the weight of the hoses below may be reduced.

In this embodiment, the first outlet OH1 and the second outlet OH2 may be open in a second direction different from a first direction, which is a direction in which a first flow path body 110 and a second flow path body 120 are coupled to each other. The first direction is the same as the X-axis direction of FIG. 1, and the second direction is a direction orthogonal to the first direction (the Z-axis direction of FIG. 1) or may be a direction extending obliquely from the direction orthogonal to the first direction.

The third outlet OH3 may not be connected to a separate hose but may be open downward. Water discharged through the third outlet OH3 may be discharged toward the floor. When a bathtub is placed under the third outlet OH3, the third outlet OH3 may be the lower water outlet 25, and when a sink bowl is placed under the third outlet OH3, the third outlet OH3 may be a sink bowl outlet.

The handle 165′ of the filter 160 described above on the lower part of the water supply device 10 may be exposed. The handle 165′ may protrude from a filter cover 165. A user may rotate the handle 165′ to separate the filter part 163 including the filter cover 165 from the water supply device 10 or mount the filter part 163 to the water supply device 10.

Reference numeral 75 denotes a manipulation button 75. The manipulation button 75 may be used to manipulate the control device (not shown) disposed inside the water supply device 10. For example, the manipulation button 75 may be a reset switch. For another example, the manipulation button 75 may be a power switch to turn on/off the display 70.

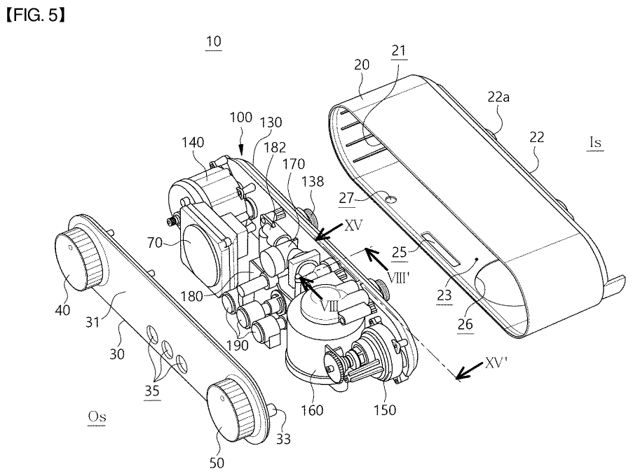

Referring to FIGS. 3 and 4, a rear surface cover 22 may be provided on the rear surface of a casing 20. The rear surface cover 22 may shield the rear of a component storage part 23. The rear surface cover 22 may have a structure that protrudes rearward from the casing 20. The rear surface cover 22 may be integrally provided on the rear of the casing 20. The rear surface cover 22 may include an inflow guide 22a for connection to the inlets IH. The inflow guide 22a may be configured as one pair of inflow guides for the inflow of hot water and cold water. Reference numeral 22b indicates a hose passage hole through which a hose passes when the hose is extended, and reference numeral 22b′ indicates a recessed portion recessed by the thickness of the hose.

Each of inlet connectors 118 may be exposed through the inflow guide 22a. The inlet connector 118 may be regarded as a type of tube protruding from the flow path guide pack 100. The pair of the inlet connectors 118 may have open inlets IH1 and IH2, respectively.

The inlet connector 118 may be connected to the raw water inlet, and thus each of the inlets IH1 and IH2 may be receive raw water. In this case, the inlet connector 118 may be surrounded by a flange 136 and flange threads 138 of the reinforcing plate 130, which will be described below. As illustrated in FIG. 4, the inlet connector 118 may be arranged concentrically with the flange threads 138.

The inlet connector 118 may not be directly connected to the installation adapter 7a or 7b, but the flange threads 138 of the reinforcing plate 130 may be connected to the installation adapter 7a or 7b. Accordingly, a load due to the weight of the water supply device 10 may not be transmitted to the inlet connector 118, but may be applied to a connection portion by the flange threads 138 and the installation adapter 7a or 7b. This structure will be described again below.

FIG. 5 illustrates an exploded view of components that constitute the water supply device 10. As is seen in the drawing, the appearance and frame of the water supply device 10 may be formed by the casing 20. The casing 20 may have the component storage part 23 provided inside. The front of the component storage part 23 may be open, and an open portion 21 thereof may be covered by a cover plate 30. In this embodiment, the casing 20 may be formed to be longer in a left and right width than in height. The upper and lower surfaces of the casing 20 may have planar structures parallel to each other. The left and right surfaces of the casing 20 may be curved surfaces. This form of the casing 20 is just one example, and the casing 20 may have various forms. The casing 20 may be regarded as a faucet body.

The lower water outlet 25 may be provided on a lower portion of the component storage part 23. The lower water outlet 25 may be connected to the third outlet OH3. Water discharged through the third outlet OH3 may fall downward through the lower water outlet 25. The lower water outlet 25 may be in the form of a long hole in the left-right direction.

A filter hole 26 may be open in a lower portion of the component storage part 23. The filter hole 26 may be made through the lower surface of the casing 20. The filter hole 26 may be considered as a hole through which the filter part 163 to be described below enters and exits. The filter hole 26 may be made circular in a lower right portion of the installation space 23. The shape of the filter hole 26 may be of various shapes corresponding to the shape of the filter part 163. Reference numeral 27 denotes a hole through which the operation button 75 protrudes. The filter hole 26 may be made circular in a lower right portion of the component storage part 23. The shape of the filter hole 26 may be of various shapes corresponding to the shape of the filter part 163. Reference numeral 27 denotes a hole through which the operation button 75 protrudes.

As illustrated in FIG. 5, the display 70, the flow path guide pack 100, the thermostat 140, the flow rate controller 150, the filter 160, the generator 170, and the water discharge selector 180 may be arranged inside the component storage part 23. Among the display 70, the flow path guide pack 100, the thermostat 140, the flow rate controller 150, the filter 160, the generator 170 and the water discharge selector 180, the display 70, the flow path guide pack 100, and the generator 170 may not be exposed to the outside but be stored in the component storage part 23. Parts of the thermostat 140, the flow rate controller 150, the filter 160, and the water discharge selector 180 may be exposed to the outside to be manipulated or replaced.

The display 70 may provide various information to a user by using power generated by the generator 170. The display 70 may include the control device. The display 70 may display information such as the temperature and flow rate of the water being discharged, the period of use of the filter part 163, the replacement time of the filter 160, and a currently selected water discharge part. The cover plate 30 may be disposed in front of the display 70, but the cover plate 30 may transmit light emitted of the display 70 forward. To this end, all or part of the cover plate 30 may be made of a transparent or translucent material. When the display 70 is configured as a touch panel, a user may input an operation command by touching the surface of the cover plate 30.

Although not shown, the control device may include a communication module for communication. The communication module may include one or more of a Bluetooth communication module, a WiFi communication module, a Zigbee communication module, and an NFC communication module. The communication modules may receive power through the generator 170.

The thermostat 140, the flow rate controller 150, the filter 160, the generator 170, and the water discharge selector 180 may each be connected to the flow path guide pack 100. Here, the connection may mean that water can pass between two parts. In this embodiment, except for the generator 170 and the water discharge selector 180, each component is not directly connected to each other, but may be indirectly connected through the flow path guide pack 100. Accordingly, the flow path guide pack 100 may provide flow paths for the flow of water. The flow path guide pack 100 may provide flow paths of sufficiently wide and predetermined sizes inside. This structure will be explained in detail again below. This structure will be described in detail again below.

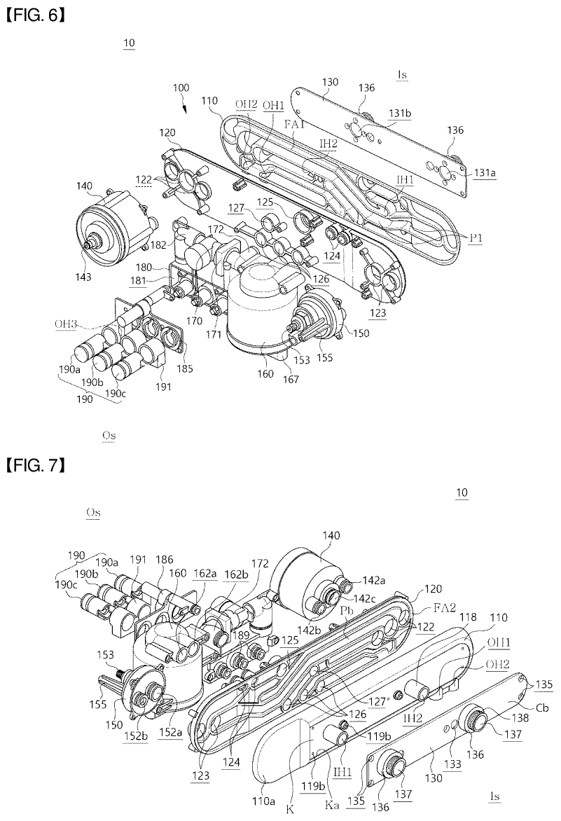

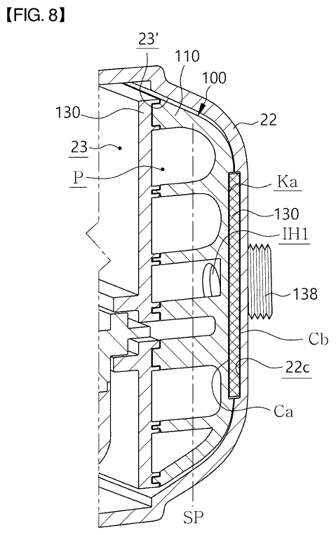

FIGS. 6 and 7 illustrate the exploded states of components arranged in the component storage part 23. FIG. 6 illustrates components viewed from a side in front of the water supply device 10, and FIG. 7 illustrates the components viewed from a side behind the water supply device 10. As illustrated in the drawings, the flow path guide pack 100 and the reinforcing plate 130 may be placed at a rearmost position. The thermostat 140, the flow rate controller 150, the filter 160, the generator 170, and the water discharge selector 180 may be arranged on the front of the flow path guide pack 100.

In this embodiment, the thermostat 140, the flow rate controller 150, the filter 160, the generator 170, and the water discharge selector 180 may be arranged left and right or up and down. More precisely, the generator 170 and the water discharge selector 180 may be arranged in a vertical direction at different heights. The thermostat 140 and the flow rate controller 150 may be arranged to be spaced apart from each other in the left-right direction. The filter 160, the generator 170, and the water discharge selector 180 may be disposed between the thermostat 140 and the flow rate controller 150. In this way, when the parts except for the flow path guide pack 100 are not arranged in the front-rear direction, but are arranged left and right or up and down, the front-to-rear length of the water supply device 10 may be minimized. As described above, when the front-to-rear length of the water supply device 10 is short, bending moments applied to the installation adapters 7a and 7b may be reduced.

The flow path guide pack 100 may be provided with a plurality of flow paths P inside. The plurality of flow paths P may transmit water to or receive water from the thermostat 140, the flow rate controller 150, the filter 160, the generator 170, and the water discharge selector 180. The flow path guide pack 100 may be considered as being dedicated to the flow paths of water. Of course, water may flow inside the thermostat 140, the flow rate controller 150, the filter 160, the generator 170, and the water discharge selector 180, but the role of transmitting water between the components may be performed by the flow path guide pack 100.

Inside the casing 20, the flow path guide pack 100 may be disposed closer to the installation adapter 7a or 7b, which is the raw water inlet, than the component storage part 23. In other words, the flow path guide pack 100 may be disposed closer to the installation surface W than the component storage part 23. The flow path guide pack 100 may be considered as being disposed at a position further from the cover plate 30 than the component storage part 23. When the flow path guide pack 100 is disposed close to the raw water inlet, it is possible to reduce a bending moment applied to the installation adapter 7a or 7b due to the weight of the flow path guide pack 100.

The above flow path guide pack 100 may be considered as defining a portion of the component storage part 23 within the casing 20. More specifically, the surface of the flow path guide pack 100 may form a portion of the component storage part 23. In this embodiment, the front surface of the flow path guide pack 100 may form the rear surface of the component storage part 23. The remaining portion of the component storage part 23 may be formed by the inner surface of the casing 20.

The flow path guide pack 100 may be arranged at a position farther from the cover plate 30 than the thermostat 140, the flow rate controller 150, the filter 160, the generator 170, and the water discharge selector 180. The flow path guide pack 100 may have a larger area than other parts, and be heavy due to the addition of the weight of water flowing through the flow paths P inside. When the flow path guide pack 100 is arranged close to the installation surface W, bending moments applied to the installation adapters 7a and 7b by the weight of the flow path guide pack 100 may be reduced.

In this embodiment, the flow path guide pack 100 may be disposed closer to the installation surface W than the thermostat 140, the flow rate controller 150, the filter 160, the generator 170, and the water discharge selector 180. Each of the installation adapters 7a and 7b, which transmit external water, may be installed on the installation surface W. When the flow path guide pack 100 is arranged close to the installation surface W, a path through which external water flows into the flow path guide pack 100 may be short.

Prior to describing the detailed structure of the flow path guide pack 100 and the flow paths P, the reinforcing plate 130 will be described. Referring to FIGS. 6 and 7, the reinforcing plate 130 may be arranged on the rear of the flow path guide pack 100. The reinforcing plate 130 may reinforce the strength of the flow path guide pack 100. The flow path guide pack 100 may be connected to the installation adapter 7a or 7b, which is the raw water inlet, and a bending moment due to the weight of the water supply device 10 may be concentrated on the connection portion of the flow path guide pack 100 and the installation adapter 7a or 7b. Accordingly, the flow path guide pack 100 may be damaged or removed from an installation position thereof. The reinforcing plate 130 may prevent the damage or removal of the flow path guide pack 100.

The reinforcing plate 130 may be disposed on a coupling portion on which the flow path guide pack 100 and the casing 20 are coupled to each other. Here, the coupling portion refers to a part on which the flow path guide pack 100 and the casing 20 are in close contact with each other. In this embodiment, the coupling portion may be a portion on which the rear surface cover 22 of the casing 20 and the first flow path body 110 are in close contact with each other.

The reinforcing plate 130 may be coupled to the flow path guide pack 100. The reinforcing plate 130 may be made of a different material from the flow path guide pack 100, thereby increasing the durability of the flow path guide pack 100. For example, the reinforcing plate 130 may be made in a plate-shaped structure made of metal. For another example, the reinforcing plate 130 may be made of reinforced plastic, such as carbon fiber reinforced plastic (CFRP).

Specifically, the reinforcing plate 130 may have a flat plate structure. The reinforcing plate 130 may be made of a high-strength metal material. The reinforcing plate 130 may be in surface contact with the surface of the flow path guide pack 100. The reinforcing plate 130 may be coupled to the first flow path body 110 in surface contact with the surface of the first flow path body 110 of the flow path guide pack 100. The installation adapter 7a or 7b may be coupled to the reinforcing plate 130. Accordingly, the installation adapter 7a or 7b may not be directly coupled to the flow path guide pack 100, but may be indirectly coupled thereto through the reinforcing plate 130.

The reinforcing plate 130 may be arranged in a direction parallel to each of the casing 20 and the flow path guide pack 100. As illustrated in FIG. 8, the reinforcing plate 130 may be erected parallel to each of the rear surface cover 22 of the casing 20 and the first flow path body 110. In this way, when the reinforcing plate 130 is arranged in a direction parallel to each of the casing 20 and the flow path guide pack 100, a coupling area between the reinforcing plate 130 and the casing 20 and a coupling area between the reinforcing plate 130 and the flow path guide pack 100 may be increased. Through this, a strength reinforcing effect due to the reinforcing plate 130 in the coupling portions may be increased.

Referring to FIG. 8, the reinforcing plate 130 may be disposed inside the rear surface cover 22 of the casing 20. The reinforcing plate 130 may be disposed between the rear surface cover 22 and the flow path guide pack 100. A first surface Ca of the reinforcing plate 130 may be in contact with the flow path guide pack 100. A second surface Cb of the reinforcing plate 130 may be in contact with the rear surface cover 22. The load of the water supply device 10 concentrated on the flange threads 138 of the reinforcing plate 130 may be transmitted to the reinforcing plate 130. In addition, the load of the water supply device 10 may be distributed to the rear surface cover 22 and the flow path guide pack 100 in contact with the reinforcing plate 130.

As illustrated in FIG. 8, the flow path guide pack 100 may have a mounting groove Ka recessed. The reinforcing plate 130 may be seated in the mounting groove Ka. Accordingly, the reinforcing plate 130 may be fixed in position without moving in an up, down, left, or right direction. Even in the rear surface cover 22, a relative mounting groove (not shown) may be recessed at a position corresponding to the mounting groove Ka.

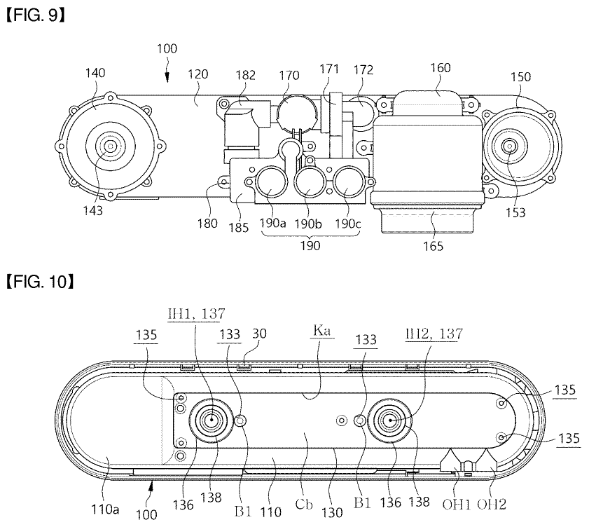

The first surface Ca of the reinforcing plate 130 may be formed smaller than the rear surface of the flow path guide pack 100. The reinforcing plate 130 may not protrude outward from the flow path guide pack 100. Referring to FIG. 10, the reinforcing plate 130 may not protrude outward from the flow path guide pack 100 in any direction, up, down, left, or right.

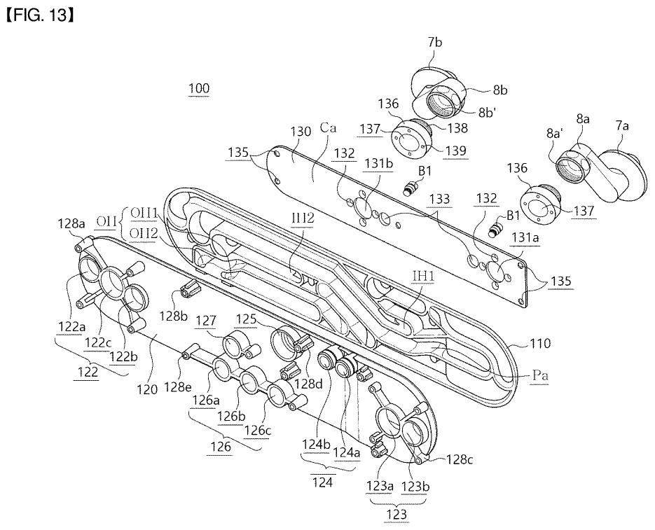

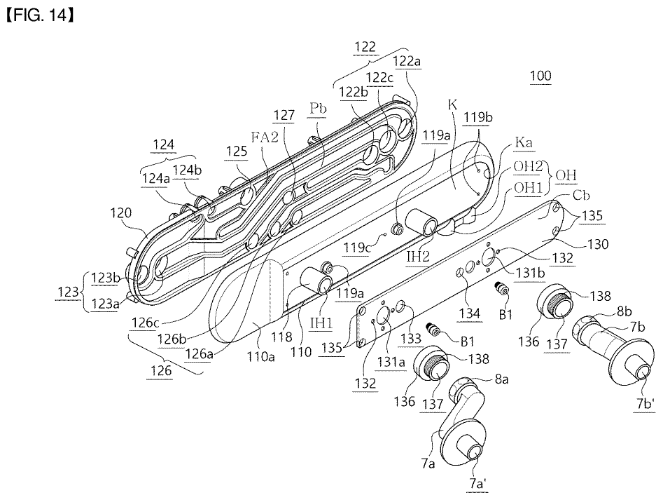

Referring to FIGS. 13 and 14, in the reinforcing plate 130, one pair of plate holes 131a and 131b may be open. Among the one pair of plate holes 131a and 131b, a first plate hole 131a may be a part through which cold water is introduced. Among the one pair of plate holes 131a and 131b, a second plate hole 131b may be a part through which hot water is introduced. The first plate hole 131a may be connected to a first adapter 7a among the installation adapters 7a and 7b, and the second plate hole 131b may be connected to a second adapter 7b among the installation adapters 7a and 7b.

Flange fastening holes 132 may be provided around the plate hole 131a or 131b. The flange fastening holes 132 are fastening holes for the coupling of the flange 136. After fasteners (not shown) pass through the flange fastening holes 132 and are fastened to fastening grooves 139 of the flange 136, the flange 136 may be fixed to the reinforcing plate 130. The flange 136 is intended to be assembled with the installation adapters 7a and 7b, and a flange thread 138 may be provided on the surface of the flange 136.

Service holes 133 may be open in the reinforcing plate 130. The service holes 133 are intended for maintenance of the water supply device 10. The service holes 133 may be connected to through holes 119a of the first flow path body 110. When a service stopper B1 is fastened to each of the through holes 119a of the first flow path body 110 after the service stopper B1 passes through each of the service holes 133, the service hole 133 and the through hole 119a may be maintained to be normally blocked. When the service stopper B1 is removed and washing water or high temperature steam is injected into the flow path guide pack 100 through the service hole 133, the flow paths P and each component inside the flow path guide pack 100 may be washed.

Body fastening holes 135 may be open in the reinforcing plate 130. The body fastening holes 135 are intended to combine the reinforcing plate 130 and the first flow path body 110 with each other. A fastener (not shown) passing through each of the body fastening holes 135 may be assembled to the fixing hole 119b of the first flow path body 110. Accordingly, the reinforcing plate 130 may be coupled to the first flow path body 110. The body fastening holes 135 may be arranged on the edge of the reinforcing plate 130.

In this embodiment, while the reinforcing plate 130 is coupled to the flow path guide pack 100, the reinforcing plate 130, together with the flow path guide pack 100, may be stored in the component storage part 23. In this case, the flange 136 of the reinforcing plate 130 may be exposed rearward through the inflow guide 22a of the rear surface cover 22. The flange 136 may be provided with the flange threads 138. The flange threads 138 may protrude rearward through the inflow guide 22a. FIG. 8 shows a state in which the flange threads 138 protrudes.

The nut parts 8a and 8b of the installation adapters 7a and 7b may be assembled with the flange threads 138 of the flange 136. In this case, raw water may be supplied into the flow path guide pack 100 through adapter inlets 7a′ and 7b′ of the installation adapters 7a and 7b. That is, in this embodiment, the installation adapter 7a or 7b, which is the raw water inlet, may not be directly coupled to the flow path guide pack 100, but may be coupled to the reinforcing plate 130.

For reference, the adapter inlets 7a′ and 7b′ of the installation adapters 7a and 7b may be connected to a raw water supply pipe (not shown) fixed to the installation surface W. Briefly looking at the installation adapters 7a and 7b with reference to FIG. 13, the installation adapters 7a and 7b may be configured as one pair of installation adapters. Cold water may be supplied through the first adapter 7a of the installation adapters 7a and 7b. Hot water may be supplied through the second adapter 7b of the installation adapters 7a and 7b. In the first adapter 7a, a first adapter inlet 7a′ may be open, and in the second adapter 7b, a second adapter inlet 7b′ may be open. Therefore, the installation adapter 7a or 7b may be regarded as the raw water inlet connected to the raw water supply pipe.

Reference numeral 8a is a first nut part 8a provided in the first adapter 7a, and reference numeral 8b is a second nut part provided in the second adapter 7b. In this embodiment, the first adapter inlet 7a′ and the first nut part 8a may have a structure eccentric to each other rather than being coaxial with each other. The first adapter 7a may be regarded as a kind of eccentric coupler. Even if there is an error in a gap between one pair of raw water supply pipes mounted in the installation surface W, the eccentric structure may allow the error to be compensated. Reference numerals 8a′ and 8b′ indicate adapter holes connected to the adapter inlets 7a′ and 7b′, respectively. Each of the adapter holes 8a′ and 8b′ may be connected to a flange hole 137 formed through the flange 136.

The flow path guide pack 100 may be erected at the rear of the component storage part 23. Here, the being erected means that the opposite ends of the flow path guide pack 100 having a width greater than the thickness of the flow path guide pack 100 based on the coupling direction of the first flow path body 110 and the second flow path body 120 constituting the flow path guide pack 100 are arranged in a vertical direction. In other words, it may be considered that opposite ends having longest sections among edges of a coupling surfaces on which the first flow path body 110 and the second flow path body 120 are coupled to each other are arranged in the vertical direction.

Referring to FIG. 9, the flow path guide pack may be installed at the rearmost position of the water supply device 10. Each of the thermostat 140, the flow rate controller 150, the filter 160, the generator 170, and the water discharge selector 180 may be arranged in whole or in part to overlap the front surface of the flow path guide pack 100 in the front-rear direction. Accordingly, the thermostat 140, the flow rate controller 150, the filter 160, the generator 170, and the water discharge selector 180 may be connected to the flow path guide pack 100 in portions overlapping the flow path guide pack 100.

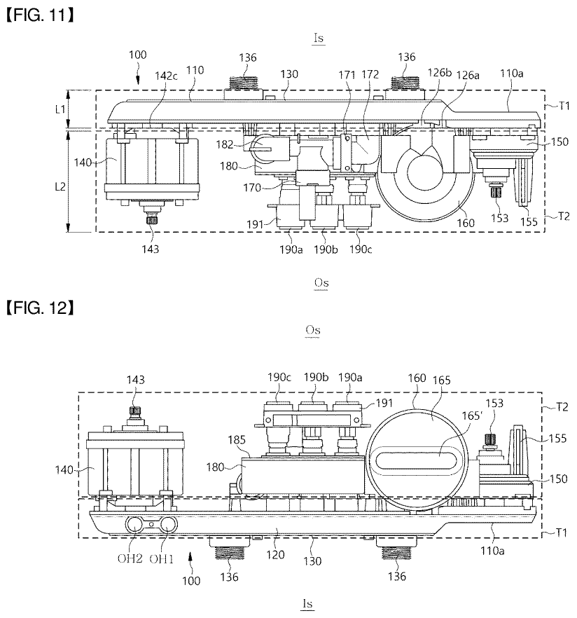

Referring to FIGS. 11 and 12, the flow path guide pack 100 may be arranged in a first area T1 of the component storage part 23. The thermostat 140, the flow rate controller 150, the filter 160, the generator 170, and the water discharge selector 180 may be arranged in a second area T2 of the component storage part 23. The first area T1 and the second area T2 may be arbitrary partitions of the component storage part 23. Here, the second area T2 may be located closer to the front surface of the casing 20 than the first area T1. Conversely, the first area T1 may be provided closer to the installation surface W than the second area T2. The above flow path guide pack 100 may be arranged in the first area T1 and may not invade the second area T2. Through this, the component storage part 23 may be utilized efficiently.

Referring to FIGS. 13 and 14, the flow path guide pack 100 may include the first flow path body 110 and the second flow path body 120. The first flow path body 110 and the second flow path body 120 may have shapes that correspond to each other. When the first flow path body 110 and the second flow path body 120 are combined with each other, the first flow path body 110 and the second flow path body 120 may have the same areas so that any one of the first flow path body 110 and the second flow path body 120 does not protrude further outside the perimeter thereof. When the first flow path body 110 and the second flow path body 120 are combined with each other, the plurality of flow paths P may be formed therebetween.

Referring to FIG. 13, first flow path parts Pa may be provided to be recessed in the first flow path body 110. Referring to FIG. 14, second flow path parts Pb may be provided to be recessed in the second flow path body 120. The first flow path parts Pa and the second flow path parts Pb may have corresponding shapes and may be located at corresponding positions. Referring to FIG. 8, the first flow path parts Pa and the second flow path parts Pb may create the flow paths P that are continuous in the front-rear direction.

The above flow paths P may form paths independent of the component storage part 23. Since the flow paths P are provided inside the flow path guide pack 100, the flow paths P may be separated from the component storage part 23 to form independent paths.

The plurality of flow paths P may be composed of individual flow paths P that are independent of each other. The individual flow paths P may (i) transmit water introduced through the inlet IH to each of parts, (ii) connect the parts to each other, and (iii) discharge water passing through the parts through an outlet OH. The individual flow paths P may have independent paths. Here, independence may mean that each of the individual flow paths P has a separated path without being connected to each other.

The first flow path body 110 and the second flow path body 120 may be respectively provided with a first close contact part FA1 and a second close contact part FA2 corresponding to each other. The first close contact part FA1 may protrude from the surface of the first flow path body 110 in a direction toward the second flow path body 120. Conversely, the second close contact part FA2 may protrude from the surface of the second flow path body 120 in a direction toward the first flow path body 110. The first close contact part FA1 and the second close contact part FA2 may be in close contact with each other to form the flow paths P. When the first close contact part FA1 and the second close contact part FA2 are in close contact with each other, the first close contact part FA1 and the second close contact part FA2 may be a kind of walls continuous in the front-rear direction, and the flow paths P may be formed between the walls.

In a portion in which the first flow path body 110 and the second flow path body 120 face each other, the flow paths P may be formed in the remaining portion except for portions on which the first close contact part FA1 and the second close contact part FA2 are in close contact with each other. That is, since the first close contact part FA1 and the second close contact part FA2 are a kind of walls continuous in the front-rear direction, the flow paths P, which are empty spaces, may be formed in the remaining portions except for a portion on which the first close contact part FA1 and the second close contact part FA2 are in close contact with each other.

The first close contact part FA1 and the second close contact part FA2 may be fused to each other. Here, “fusion” means “being fixed to each other” in close contact with each other. The first close contact part FA1 and the second close contact part FA2 may be fused to each other by using vibration fusion, heat fusion, or ultrasonic fusion. The heat fusion may be implemented in a method in which after heating, softening, and melting the first flow path body 110 and the second flow path body 120 fixed to two jigs by pressing the first flow path body 110 and the second flow path body 120 with a hot plate heated to a temperature slightly higher than the melting temperature of the material of the first flow path body 110 and the second flow path body 120, when fusing areas are sufficiently melted, the hot plate is removed, the first flow path body 110 and the second flow path body 120 are pressed to each other, and then are cooled until hardened to fuse the first flow path body 110 and the second flow path body 120.

For another example, the first close contact part FA1 and the second close contact part FA2 may be coupled to each other by bonding. For still another example, the first flow path body 110 and the second flow path body 120 may be coupled to each other by using separate fasteners such as screws. In this case, the first close contact part FA1 and the second close contact part FA2 may be sealed by using a rubber sealing member.

Referring to FIG. 13, when looking at the first flow path body 110 constituting the flow path guide pack 100, the inlets IH may be provided in the first flow path body 110. The inlet IH may be a part for supplying external raw water into the flow paths P. Cold and hot water may be supplied through the inlet IH. In this embodiment, the inlet IH may include a first inlet IH for cold water inflow and a second inlet IH for hot water inflow. For another example, only one inlet IH may be provided in the first flow path body 110.

The inlet IH may be open in the front-rear direction in the first flow path body 110. More specifically, the first flow path body 110 and the second flow path body 120 may be coupled to each other in the first direction (the front-rear direction), and the inlet IH may also be open in the first direction. In this case, the inlet IH may be provided by penetrating a wide portion of the first flow path body 110, and the diameter of the inlet IH may be increased. When the diameter of the inlet IH increases, external raw water may be introduced efficiently through the inlet IH. When the diameter of the inlet IH is small, water pressure in the inlet IH may increase, and cracks and water leaks may occur in a fused portion between the first flow path body 110 and the second flow path body 120. In this embodiment, the inlet IH may also be open in the first direction to reduce the water pressure.

The first flow path body 110 may include an outlet OH. The outlet OH may be a part through which water passing through the flow path guide pack 100 is discharged to the outside. Here, the outside refers to space to which water is discharged through the outlet. A separate hose may be coupled to the outlet OH, allowing water to be discharged at a distant location.

In this embodiment, the outlet OH may include the first outlet OH1, the second outlet OH2, and the third outlet OH3. The first outlet OH1 and the second outlet OH2 may be arranged to be adjacent to each other, but in another example, the first outlet OH1 and the second outlet OH2 may be spaced apart from each other.

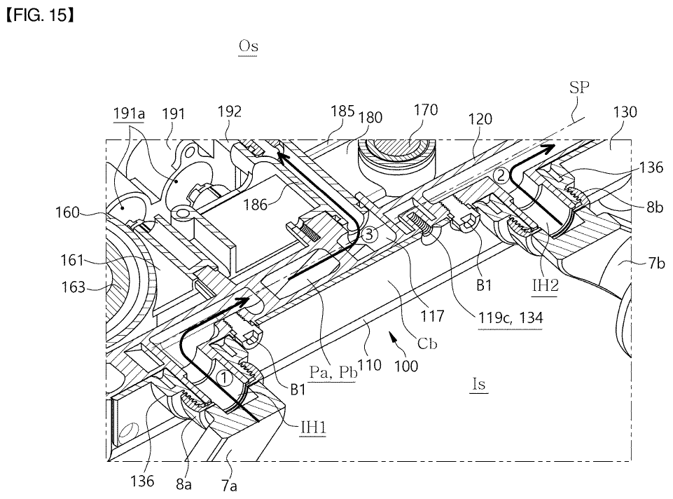

As illustrated in FIG. 6, the first outlet OH1 and the second outlet OH2 may be disposed in the first flow path body 110. On the other hand, the third outlet OH3 may be arranged not in the first flow path body 110 but in the water discharge selector 180. Referring to FIG. 15, a movement guide 191 constituting the water discharge selector 180 may include a guide water discharge pipe 192 whose first end part is inserted into the flow path guide pack 100, and the third outlet OH3 may be provided on an end of the guide water discharge pipe 192. For another example, the guide water discharge pipe 192 of the movement guide 191 may be omitted, and the third outlet OH3 may be provided in the flow path guide pack 100.

Referring to FIG. 14, the first flow path body 110 may be provided with the through hole 119a. The service stopper B1 may be coupled to the through hole 119a. Each of fixing holes 119b to which the fastener is fastened may be disposed on the edge of the first flow path body 110. Reference numeral 119c denotes an additional fixing hole corresponding to the additional fastening hole of the reinforcing plate 130. A separate fastener (not shown) may be fastened to the additional fixing hole 119c, so that a fastening force between the reinforcing plate 130 and the first flow path body 110 may be increased.

Referring to FIGS. 13 and 14, the first flow path body 110 may include a plurality of flow paths P. The plurality of flow paths P may each perform different functions. The plurality of flow paths P may extend in left-right directions. The plurality of flow paths P may extend in inclined directions in some sections. The specific function of each of the flow paths P will be described again below.

The plurality of flow paths P may be arranged on the same plane inside the flow path guide pack 100. In FIGS. 8 and 15, reference numeral SP indicates a plane crossing the inside of the flow path guide pack 100. Here, the same plane refers to a virtual plane and may refer to a plane made by a Y-axis and a Z-axis in FIG. 1.

The plurality of flow paths P may be provided in a direction orthogonal to the coupling direction of the first flow path body 110 and the second flow path body 120. In this embodiment, each of the plurality of flow paths P may be formed in a direction orthogonal to a direction in which each of the inlets IH1 and IH2 and the connectors 122, 123, 124, 125, 126, and 127 is open. Accordingly, it is possible to reduce hydraulic pressure applied in a direction in which each of the first flow path body 110 and the second flow path body 120 is separated from each other. In addition, the plurality of flow paths P may be provided in a wide range by utilizing the areas of the first flow path body 110 and the second flow path body 120.

Meanwhile, looking at the second flow path body 120, the second flow path body 120, like the first flow path body 110, may be made into a flat plate structure. Referring to FIGS. 13 and 14, the second path corresponding to the first path of the first flow path body 110 may be formed in a recessed form in the second flow path body 120. The second path Pb may be connected to the first path Pa to form one path.

The second flow path body 120 may be provided with a plurality of connectors 122, 123, 124, 125, 126, and 127. The connectors 122, 123, 124, 125, 126, and 127 are intended to connect the flow paths P with components disposed on the outside of the flow path guide pack 100. Some of the connectors 122, 123, 124, 125, 126, and 127 may constitute a portion through which water is discharged from the flow path guide pack 100. Accordingly, some of the connectors 122, 123, 124, 125, 126, and 127 may be considered to constitute an outlet.

The connectors 122, 123, 124, 125, 126, and 127 may be formed in the second flow path body 120 in the front-rear direction (the X-axis direction in FIG. 1), which is a coupling direction of the second flow path body 120 and the first flow path body 110. It may be described that some of the plurality of flow paths P are open toward the component storage part 23. The inlets IH1 and IH2 and the plurality of connectors 122, 123, 124, 125, 126, and 127 may be open in opposite directions. The inlets IH1 and IH2, the outlets OH1, OH2, and OH3, and the plurality of connectors 122, 123, 124, 125, 126, and 127 may be open in directions different from each other.

Accordingly, when the connectors 122,123,124, 125,126, and 127 are open in the first direction in which the first flow path body 110 and the second flow path body 120 are combined with each other, the connectors 122,123,124, 125,126, and 127 may be arranged at various locations by using the wide surface of the second flow path body 120. In addition, when the connectors 122, 123, 124, 125, 126, and 127 are open in the first direction in which the first flow path body 110 and the second flow path body 120 are coupled to each other, components such as the generator 170 and the filter 160 may be arranged side by side on the front of the flow path guide pack 100.

The connector may include a temperature control connector 122 connected to the thermostat 140. The temperature control connector 122 may be connected to each of the first inlet pipe 142a (see FIG. 7), the second inlet pipe 142b (see FIG. 7), and the discharge pipe 142c (see FIG. 7) of the thermostat 140. To this end, the temperature control connector 122 may include a first temperature control connector 122a, a second temperature control connector 122b, and a third temperature control connector 122c.

The connector may include a flow-rate control connector 123 connected to the flow rate controller 150. The flow-rate control connector 123 may be arranged on the opposite side of the temperature control connector 122. The flow-rate control connector 123 may be connected to each of the control inlet 152a (see FIG. 7) and the control outlet 152b (see FIG. 7) of the flow rate controller 150. To this end, the flow-rate control connector 123 may include a first flow-rate control connector 123a and a second flow-rate control connector 123b.

The connector may include a filter connector 124 connected to the filter 160. The filter connector 124 may be connected to each of a filter inlet 162a (see FIG. 7) and a filter outlet 162b (see FIG. 7) of the filter 160. To this end, the filter connector 124 may include a first filter connector 124a and a second filter connector 124b.

The connector may include a generator connector 125 connected to the generator 170. The generator connector 125 may be connected to the power generation inlet 172 (see FIG. 7) of the generator 170. The generator connector 125 may be provided at a position corresponding to the power supply point 115 of the first flow path body 110. The filter inlet 162a and the filter outlet 162b may be arranged at a higher or equal position than the power generation inlet 172.

The connector may include a selector connector 126 connected to the water discharge selector 180. The selector connector 126 may be connected to each of a plurality of selector outlets 189 (see FIG. 7) provided in the water discharge selector 180. To this end, as illustrated in FIG. 13, the selector connector 126 may include a first selector connector 126a, a second selector connector 126b, and a third selector connector 126c.

The connector may include a water discharge connector 127 connected to the selector water discharge pipe 186 (see FIG. 15) of the water discharge selector 180. The water discharge connector 127 may discharge purified water in a direction toward the third outlet OH3 through the selector water discharge pipe 186.

Referring to FIG. 13, the second flow path body 120 may be provided with fixing parts for fixing the parts. The fixing parts may protrude forward from the surface of the second flow path body 120, that is, toward the cover plate 30. Fasteners (not shown) such as screws may be fastened to the fixing parts to fix components. Reference numeral 128a denotes a first fixing part for fixing the thermostat 140. Reference numeral 128b denotes a second fixing part for fixing the generator 170. Reference numeral 128c denotes a third fixing part for fixing the flow rate controller 150. Reference numeral 128d denotes a fourth fixing part for fixing the filter 160. Reference numeral 128e denotes a fifth fixing part for fixing the water discharge selector 180.

Looking at the controller, the controller may include the thermostat 140 and the flow rate controller 150. Referring to FIGS. 6 and 7, the thermostat 140 may be provided with the first inlet pipe 142a, the second inlet pipe 142b, and the discharge pipe 142c. Cold water may flow into the first inlet pipe 142a. Cold water may flow into the first inlet pipe 142a. The first inlet pipe 142a may be connected to the first temperature control connector 122a of the flow path guide pack 100. Hot water may flow into the second inlet pipe 142b. The second inlet pipe 142b may be connected to the second temperature control connector 122b of the flow path guide pack 100. The cold water, hot water, or mixed water may be discharged through the discharge pipe 142c. The discharge pipe 142c may be connected to the third temperature control connector 122c of the flow path guide pack 100.

A first knob connection part 143 may be provided on the front surface of the thermostat 140. The first knob connection part 143 may be connected to the first knob 40. The first knob connection part 143 may be configured as a kind of gear.

The thermostat 140 may mix incoming cold water and hot water to control a temperature of mixed water. In this case, the thermostat 140 may be regarded as a kind of valve. In this embodiment, the thermostat 140 may implement a constant temperature function that maintains the temperature of the mixed water around a set temperature. The thermostat 140 may control the ratio of cold and hot water mixed by controlling the degree of the opening of a valve that opens and closes inside.

The flow rate controller 150 may control the discharge amount of mixed water and transmit the controlled mixed water to the filter 160. The flow rate controller 150 may be provided with the control inlet 152a and the control outlet 152b. The mixed water may flow into the control inlet 152a. Controlled water of a flow rate controlled inside the flow rate controller 150 may be discharged through the control outlet 152b. The control inlet 152a and the control outlet 152b of the flow rate controller 150 may be connected to the first flow-rate control connector 123a and the second flow-rate control connector 123b of the flow path guide pack 100, respectively.

A second knob connection part 153 may be provided on the front surface of the flow rate controller 150. The second knob connection part 153 may be connected to the second knob 50. The second knob connection part 153 may be configured as a kind of gear. Reference numeral 155 denotes a front fastening part. The front fastening part 155 may be coupled to the cover plate 30 through a separate fastener (not shown). The front fastening part 155 may protrude toward the cover plate 30.

Looking at the filter 160, the filter 160 may include the filter inlet 162a and the filter outlet 162b. The filter inlet 162a and the filter outlet 162b may be provided on the upper portion of the filter 160. The filter inlet 162a and the filter outlet 162b may each be open toward the flow path guide pack 100. The filter inlet 162a may be disposed to be biased toward the edge of the filter 160 compared to the filter outlet 162b. Controlled water introduced into the filter inlet 162a may be introduced into a first filter space of the filter part mounted inside the filter 160 and discharged to a second filter space to be purified.

A filter cover 165 may be provided on the lower end of the filter 160. The filter cover 165 may be exposed to the lower part of the casing 20 when the filter 160 is mounted on the water supply device 10. The filter cover 165 may be provided with the handle 165′. The handle 165′ may be gripped and rotated when a user replaces the filter part 163.

FIGS. 6 and 7 illustrate the generator 170 and the water discharge selector 180. Looking at the generator 170, the generator 170 may be a water-flow generator 170 (hereinafter, referred to as a generator) that uses high-speed water flow caused by the flow of purified water. Although not shown, the inside of the generator 170 may include an impeller that is rotated by pressure of purified water and a small power generation means connected to the impeller. Electrical energy generated by the power generation means may be transferred to a battery. The generator 170 may have a built-in battery, or the display 70 may be provided with a battery. The generator 170 and the display 70 may be electrically connected to each other through a wire (not shown).

The generator 170 may be provided with the power generation inlet 172 and a power generation outlet 182. The power generation inlet 172 may be a part through which purified water is introduced, and the power generation outlet 182 may be a part through which purified water that has completed power generation is discharged. The power generation inlet 172 may be connected to the generator connector 125 of the flow path guide pack 100. Reference numeral 171 may be a fixing bracket 171 for fixing the generator 170. The fixing bracket 171 may be fixed to a mounting plate 184 of the water discharge selector 180. The power generation outlet 182 may be regarded as a part of the water discharge selector 180.

The power generation outlet 182 may be open downward. The power generation outlet 182 may be connected to a selector entrance 181a of the water discharge selector 180. In this embodiment, the generator 170 and the water discharge selector 180 may be connected to each other without going through the flow path guide pack 100. For another example, the generator 170 and the water discharge selector 180 may be connected to each other through the flow path guide pack 100.

Referring to the water discharge selector 180, the water discharge selector 180 may include a water storage space 181 (see FIG. 6) provided inside. The water discharge selector 180 may be made into an approximately hexahedral structure. A selector cover 185 may be provided on the front of the water discharge selector 180. The selector cover 185 may have a flat plate structure. The selector cover 185 may cover the front surface of the water discharge selector 180. The selection levers 190, which are a type of buttons, may pass through the selector cover 185.

Referring to FIGS. 7 and 15, the selector cover 185 may be provided with the selector water discharge pipe 186. The selector water discharge pipe 186 may extend in the front-rear direction on the upper portion of the selector cover 185. The selector water discharge pipe 186 may be connected to the water discharge connector 127 of the flow path guide pack 100. In addition, the third outlet (see FIG. 6) may be provided on an end portion of the guide water discharge pipe 192 provided in the selection levers 190, so that purified water may finally be discharged through the third outlet OH3.

The generator 170 and the water discharge selector 180 may be arranged at different heights. When the generator 170 and the water discharge selector 180 are stacked in a vertical direction, a total volume occupied by the generator 170 and the water discharge selector 180 in the component storage part 23 may be reduced. When the generator 170 and the water discharge selector 180 are stacked in the vertical direction, a short flow path that directly connects the generator 170 and the water discharge selector 180 to each other may be formed. In addition, the above generator 170 may be disposed on a rear side closer to the flow path guide pack 100 than the water discharge selector 180.

The water supply device 10 may be provided with the selection levers 190. The selection levers 190 may be connected to the water discharge selector 180 to be described below. The water discharge selector 180 may allow a user to select which of the plurality of water discharge parts to discharge water through. In this embodiment, the water discharge selector 180 may include a total of three selection levers 190a, 190b, and 190c. The three selection levers 190 may allow water to be discharged through the rainfall shower head 2, the handheld shower head 4, and the lower water outlet 25, respectively. The three selection levers 190a, 190b, and 190c may each be connected to the water discharge selector 180.

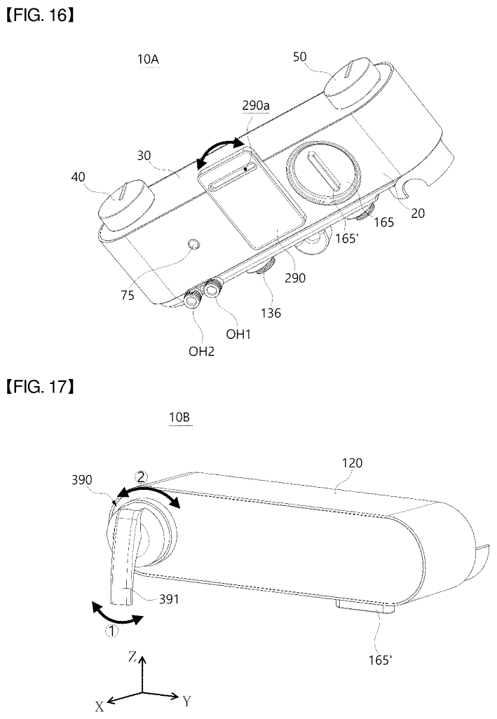

FIG. 16 illustrates a second embodiment of the water supply device 10 according to the present disclosure. As shown, the water supply device 10A may include a water discharge selector 290 that rotates. The water discharge selector 290 may be rotated in the direction of an arrow. When the water discharge selector 290 is rotated, purified water passing through the flow path guide pack 100 may be selectively discharged through the first outlet OH1, the second outlet OH2, or the third outlet (not shown). Reference numeral 290a refers to a bathtub faucet, and the bathtub faucet 290a may be connected to the third outlet disposed inside.

For example, when the water discharge selector 290 is rotated counterclockwise, purified water may be discharged through the first outlet OH1. When the water discharge selector 290 is rotated clockwise, purified water may be discharged through the second outlet OH2. When the water discharge selector 290 is aligned toward the front as shown in FIG. 30, purified water may be discharged through the third outlet. For this operation, a branch valve connected to the water discharge selector 290 may be disposed inside the water supply device 10A.

FIG. 17 illustrates a third embodiment of a water supply device 10B according to the present disclosure. As illustrated in FIG. 17, the water supply device 10B may include only one control knob 390. The control knob 390 may be rotated in a first direction (a direction of arrow \hat{1}) or in a second direction (a direction of arrow \hat{2}). The first direction is based on the Y-axis of FIG. 1 as the center of rotation, and the second direction is based on the X-axis of FIG. 1 as the center of rotation.

When the control knob 390 is rotated in the first direction, the controller provided inside the water supply device 10B may control a discharge flow rate. In addition, when the control knob 390 is rotated in the second direction, the controller provided inside the water supply device 10B may control a discharge temperature. Accordingly, in this embodiment, the controller may control both flow rate and temperature. Reference numeral 391 denotes a holding portion of the control knob 390.

The above description is merely an illustrative description of the technical idea of the present disclosure, and those skilled in the art to which the present disclosure belongs may make various modifications and variations without departing from the essential characteristics of the present disclosure. Accordingly, the embodiments disclosed in the present disclosure are not intended to limit but describe the technical idea of the present disclosure, and the scope of the technical idea of the present disclosure is not limited by the embodiments. The scope of protection of the present disclosure should be interpreted in accordance with the claims below, and all technical ideas within the equivalent scope should be interpreted as being included in the scope of the claims of the present disclosure.

1. A water supply device comprising:
a casing;
a component storage part formed inside the casing;
a flow path guide pack which is disposed inside the casing and defines a portion of the component storage part;
a thermostat connected to the flow path guide pack;
a flow rate controller connected to the flow path guide pack;
a filter connected to the flow path guide pack; and
a water-flow generator connected to the flow path guide pack,
wherein the thermostat, the flow rate controller, the filter, and the water-flow generator are disposed in the component storage part, and
the filter and the water-flow generator are disposed between the flow rate controller and the thermostat.

2. The water supply device of claim 1, wherein the water-flow generator and the filter are disposed on a front of the flow path guide pack.

3. The water supply device of claim 1, wherein the water-flow generator and the filter are disposed to be spaced apart from each other on left and right.

4. The water supply device of claim 1, wherein the water-flow generator and the filter are received in the component storage part in a first direction which is a front-rear direction,
wherein the water-flow generator and the filter are connected to the flow path guide pack in the first direction.

5. The water supply device of claim 4, wherein flow paths formed inside the flow path guide pack are formed in a second direction orthogonal to the first direction.

6. The water supply device of claim 5, wherein a filter part is stored inside the filter,
wherein the filter part is attached and detached in the second direction.

7. The water supply device of claim 1, wherein the filter is disposed closer to the flow rate controller than the water-flow generator.

8. The water supply device of claim 1, wherein each of a filter inlet and a filter outlet of the filter connected to the flow path guide pack is open in a front-rear direction toward the flow path guide pack, and
a power generation inlet of the water-flow generator connected to the flow path guide pack is open in the front-rear direction toward the flow path guide pack.

9. The water supply device of claim 8, wherein the filter inlet and the filter outlet are disposed on a higher or equal position than the power generation inlet.

10. The water supply device of claim 1, wherein a water discharge selector which selectively discharges raw water inside the flow path guide pack to an outside is disposed in the component storage part, and
the water-flow generator is disposed on a rear side closer to the flow path guide pack than the water discharge selector.

11. The water supply device of claim 1, wherein the water-flow generator is stacked on an upper portion of a water discharge selector.

12. The water supply device of claim 11, wherein the water-flow generator comprises:
a power generation inlet connected to the flow path guide pack; and
a power generation outlet connected to the water discharge selector.

13. The water supply device of claim 1, wherein a lower end of the water-flow generator is spaced further apart upward from a bottom surface of the component storage part than a lower end of the filter.

14. The water supply device of claim 1, wherein a display which receives power from the water-flow generator is disposed in the component storage part.

15. The water supply device of claim 14, wherein the display is disposed on an opposite side of the filter, relative to the water-flow generator.

16. The water supply device of claim 14, wherein the display is disposed between the flow rate controller and the thermostat, and
wherein the display is disposed closer to the thermostat than the flow rate controller.

17. The water supply device of claim 1, wherein the flow path guide pack is provided with an inlet through which external raw water is introduced,
wherein the inlet is open in a first direction in which the filter and the water-flow generator are connected to the flow path guide pack, and
the inlet is provided on an opposite side of the component storage part, relative to the flow path guide pack.

18. The water supply device of claim 1, wherein the flow path guide pack is provided with a pair of inlets through which external raw water is introduced,
wherein the pair of inlets is disposed between the flow rate controller and the thermostat.

19. The water supply device of claim 17, wherein the flow path guide pack is provided with an outlet configured to supply the raw water to an outside,
wherein the outlet is open in a second direction orthogonal to the first direction.

20. A faucet comprising:
a casing;
a component storage part formed inside the casing;
a flow path guide pack which is disposed inside the casing and defines a portion of the component storage part;
a thermostat connected to the flow path guide pack;
a flow rate controller connected to the flow path guide pack;
a filter connected to the flow path guide pack; and
a water-flow generator connected to the flow path guide pack,
wherein the thermostat, the flow rate controller, the filter, and the water-flow generator are disposed in the component storage part, and
the filter and the water-flow generator are disposed between the flow rate controller and the thermostat.
